(19) United States
(12) Patent Application Publication
(10) Pub. No.: US 2007/0285415 A1
(43) Pub. Date: Dec. 13, 2007

(54) Plasma display and driving method thereof

(76) Inventor: Ki-Hyung Park, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/730,111

(22) Filed: Mar. 29, 2007

(30) Foreign Application Priority Data
Apr. 28, 2006 (KR) 10-2006-0038683

(51) Int. Cl. G06F 3/038

(52) U.S. Cl. 345/212

(57) ABSTRACT

In a plasma display device, row electrodes are divided into first and second row groups, the row electrodes of the first row group are divided into first subgroups, and the row electrodes of the second row group are divided into second subgroups to be driven. A first voltage and a second voltage are alternately applied to the row electrodes of light emitting cells of at least one second subgroup, and a non-light emitting cell is selected among light emitting cells of at least one first subgroup. The first voltage and the second voltage are alternately applied to the row electrodes of light emitting cells of the at least one first subgroup, and a non-light emitting cell is selected among light emitting cells of the at least one second subgroup. The non-light emitting cell is selected after the first voltage is applied to the row electrode for a predetermined period.

### BACKGROUND OF THE INVENTION

1. Field of the Invention

The present invention relates to a plasma display device and a driving method thereof.

2. Description of the Related Art

A plasma display device is a flat panel display that includes a plurality of discharge cells, in which plasma generated by a gas discharge process is used to display characters or images. A field (e.g., 1 TV field) used for display may be divided into a plurality of subfields, each having a respective weight. Each subfield may include an address period, in which an address operation occurs for selecting discharge cells to emit light and discharge cells to not emit light from among a plurality of discharge cells, and a sustain period, in which a sustain discharge occurs in the selected light emitting discharge cells during a period corresponding to the weight of the subfield.

Such a plasma display device uses subfields having different weight values to express grayscales. A grayscale of the corresponding discharge cell is expressed by a total of the weight values of subfields in which the discharge cell emits light among the plurality of subfields. An observer will integrate the subfields over a field to view the correct grayscale. However, when similar grayscales in consecutive fields have much different subfield arrangements, a false contour (dynamic false contour) may occur. For example, when the subfields with weights in the format of a power of 2 are used, a false contour (dynamic false contour) may occur when a discharge cell expresses the grayscales of 127 and 128, i.e., when the subfield arrangement changes from seven of the eight subfields being used to only the eighth subfield being used, in two consecutive fields.

In addition, when address and sustain periods are separated with a predetermined interval therebetween, the length of one subfield becomes longer because respective subfields have additional address periods for addressing all the discharge cells. As a result, the number of subfields available in one field is reduced.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention is therefore directed to a plasma display and a driving method thereof, which substantially overcomes one or more of the problems due to the limitations and disadvantages of the related art.

It is therefore a feature of an embodiment of the present invention to reduce a false contour.

It is therefore another feature of an embodiment of the present invention to reduce a subfield length.

It is yet another feature of an embodiment of the present invention to generate a stable erase discharge in a subfield using an erase method depending on temperature.

At least one of the above and other features and advantages of the present invention may be realized by providing a method of driving a plasma display device having a plurality of row electrodes, a plurality of column electrodes, and a plurality of discharge cells defined by the plurality of row and column electrodes, wherein one field is divided into a plurality of subfields, the driving method including, at each of a plurality of consecutive first subfields, dividing the row electrodes into a first row group and a second row group, dividing the first row group into a plurality of first subgroups, and dividing the second row group into a plurality of second subgroups, alternately applying a low voltage and a high voltage to row electrodes of at least one second subgroup, and selecting a non-light emitting cell from among light emitting cells of at least one first subgroup after the high voltage is applied to the row electrodes of the at least one second subgroup for a predetermined period.

The predetermined period may be inversely proportional to a temperature of the plasma display device. A period for applying the high voltage to the row electrode may be directly proportional to a temperature of the plasma display device.

The non-light emitting cell may not be selected while the voltage at the row electrodes of the at least one second subgroup changes from the high voltage to the low voltage, changes from the low voltage to the high voltage, and during the predetermined period.

The row electrodes may include a plurality of first electrodes and a plurality of second electrodes, and alternately applying the low voltage and the high voltage may include applying the low voltage and the high voltage in opposite phases to the first electrodes and the second electrodes in the at least one second row subgroup. The selecting of the non-light emitting cell from among the light emitting cells of the first subgroup may include sequentially applying a scan pulse to the first electrode belonging to the at least one first subgroup, and applying an address pulse to the column electrode of the non-light emitting cell from among the light emitting cells formed by the first electrode to which the scan pulse is applied.

The method may further include alternately applying the low voltage and the high voltage to the row electrode of at least one first subgroup, and selecting a non-light emitting cell from among light emitting cells of at least one second subgroup after the high voltage is applied to the row electrodes of the at least one second subgroup for the predetermined period.

The method may further include, during second subfields prior to the plurality of first subfields, selecting light emitting cells from discharge cells of the first row group and sustain-discharging light emitting cells of the first row group of light emitting cells, and selecting light emitting cells from discharge cells of the second row group and sustain-discharging light emitting cells of the second row group. The method may further include, during the second subfields, setting the plurality of discharge cells as non-light emitting cells before selecting the light emitting cells from among the first row group of discharge cells.

At least one of the above and other features and advantages of the present invention may be realized by providing a plasma display device, including a plasma display panel (PDP) including a plurality of row electrodes, a plurality of column electrodes, and a plurality of discharge cells defined by the row electrodes and the column electrodes, a controller configured to divide a field into a plurality of subfields, the row electrodes into a first row group and a second row group, and the row electrodes of the first and second row groups into a plurality of first subgroups and a plurality of second subgroups, respectively, and a driver configured to apply a sustain pulse to the row electrodes belonging to the second subgroups while selecting a non-light emitting cell from among light emitting cells of the first subgroups during a first period, and to apply the sustain pulse to the row electrodes belonging to the first subgroups while selecting a non-light emitting cell from among the light emitting cells of the respective second subgroups during a second period, wherein the sustain pulse alternately has a low level voltage and a high level voltage, and the driver selects the non-light emitting cell after the high voltage is applied to the row electrodes for a predetermined period.

The driver may not select the non-light emitting cell while the sustain pulse has the low level voltage and during the predetermined period.

The plasma display device may further include a temperature sensor for sensing a temperature of the PDP, wherein the controller may set the predetermined period in accordance with the temperature of the PDP.

The driver may apply a first voltage to the column electrode of the selected non-light emitting cell, and a second voltage that is lower than the first voltage to the column electrode of a non-light emitting cell that is not selected.

At least one of the above and other features and advantages of the present invention may be realized by providing a method of driving a plasma display device having a plurality of row electrodes, a plurality of column electrodes, and a plurality of discharge cells defined by the plurality of row and column electrodes, each of the row electrodes including a first electrode and a second electrode, wherein one field is divided into a plurality of subfields, the method including dividing the first electrodes into a first row group and a second row group, dividing the first electrodes of the first row group into a plurality of first subgroups, and dividing the first electrodes of the second row group into a plurality of second subgroups, in at least one subfield from among the subfields, applying a first sustain pulse and a second sustain pulse in opposite phases to the first electrode and the second electrode of light emitting cells of at least one second subgroup, and selecting a non-light emitting cell from among light emitting cells of at least one first subgroup, and in the at least one subfield, applying the first sustain pulse and the second sustain pulse in opposite phases to the first electrode and the second electrode of the light emitting cells of at least one first subgroup, and applying an address pulse to a column electrode of a non-light emitting cell from among light emitting cells of the at least one second subgroup, wherein the first and second sustain pulses alternately have a high level voltage and a low level voltage, and the address pulse is applied to the column electrode of the non-light emitting cell after the high voltage is applied to the first electrode or the second electrode for a predetermined period.

The predetermined period may be determined based on a temperature of the plasma display device. The predetermined period may be inversely proportional to the temperature of the plasma display device. The predetermined period may be increased when a temperature of the plasma display device is lower than a reference temperature and may be decreased when the temperature of the plasma display device is higher than the reference temperature. A period of the high level voltage of the sustain pulse may be directly proportional to a temperature of the plasma display device.

The method may further include, during a second subfield prior to a first subfield, selecting light emitting cells from discharge cells of the first row group and sustain-discharging light emitting cells of the first row group, and selecting light emitting cells from discharge cells of the second row group and sustain-discharging light emitting cells of the second row group. In the second subfield, the discharge cells may be set to be non-light emitting cells before selecting the light emitting cells from among the discharge cells of the first row group.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic diagram of a plasma display device according to an exemplary embodiment of the present invention;

FIG. 2 illustrates a diagram of a grouping method of the respective electrodes used in a driving method of a plasma display device according to an exemplary embodiment of the present invention;

FIG. 3 illustrates a schematic diagram of a driving method of a plasma display device according to a first exemplary embodiment of the present invention;

FIG. 4 illustrates a driving method of FIG. 3 using only subfields;

FIG. 5 illustrates a driving waveform of a plasma display device according to the driving method of FIG. 3;

FIG. 6 illustrates a driving waveform in a sustain period of a subgroup of a first row group in the driving waveform shown in FIG. 5;

FIG. 7 illustrates another driving waveform of a sustain period according to an exemplary embodiment of the present invention;

FIG. 8 illustrates a method of operating the controller shown in FIG. 1;

FIG. 9A and FIG. 9B illustrate driving waveforms of a sustain period according to an exemplary embodiment of the present invention; and

FIG. 10 illustrates a schematic diagram of a driving method of a plasma display device according to a second exemplary embodiment of the present invention.

### DETAILED DESCRIPTION OF THE INVENTION

Korean Patent Application No. 10-2006-0038683 filed on Apr. 28, 2006 in the Korean Intellectual Property Office, and entitled: “Plasma Display and Driving Method Thereof,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

To clarify the present invention, parts that are not described in the specification are omitted, and parts for which similar descriptions are provided have the same reference numerals.

In addition, unless explicitly described to the contrary, the word “comprise” and variations such as “comprises” or “comprising” will be understood to imply the inclusion of stated elements but not the exclusion of any other elements.

A wall charge in the present invention represents charges formed and accumulated on a wall (e.g., a dielectric layer) close to an electrode of a discharge cell. The wall charge does not actually contact the electrode, and the wall charge will be described as being “formed” or “accumulated” on the electrode. Also, a wall voltage indicates a potential difference formed on the wall of a cell by the wall charge.

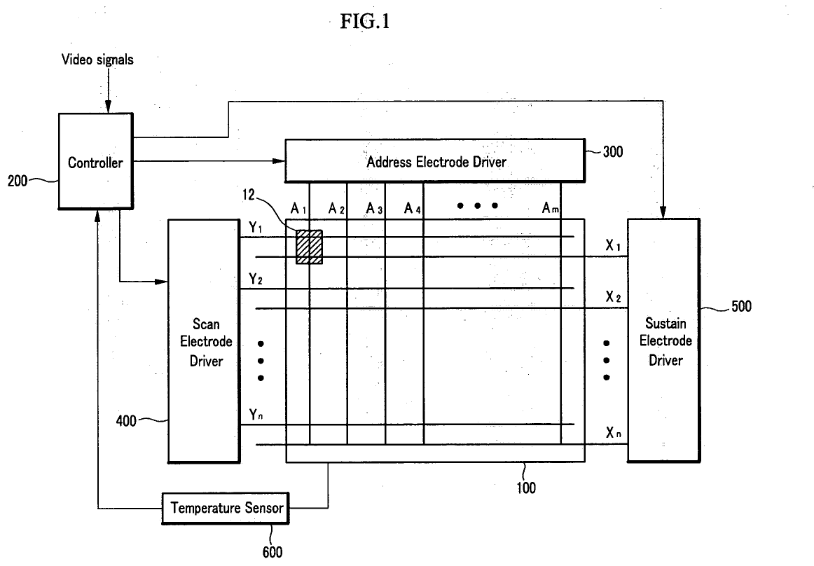

A plasma display device according to an exemplary embodiment of the present invention will now be described with reference to FIG. 1.

FIG. 1 illustrates a plasma display device according to an exemplary embodiment of the present invention.

As shown in FIG. 1, the plasma display device according to the exemplary embodiment of the present invention may include a plasma display panel (PDP) 100, a controller 200, an address electrode driver 300, a scan electrode driver 400, a sustain electrode driver 500, and a temperature sensor 600.

The PDP 100 may include a plurality of address electrodes A₁ to Aₘ (hereinafter referred to as “A electrodes”) extending in a column direction, and a plurality of sustain and scan electrodes X₁ to Xₙ and Y₁ to Yₙ (hereinafter respectively referred to as “X electrodes” and “Y electrodes”) extending in a row direction by pairs. The X electrodes X₁ to Xₙ may be formed in correspondence to the Y electrodes Y₁ to Y_{n/2} and a display operation may be performed by the X and Y electrodes during the sustain period. The Y and X electrodes Y₁ to Yₙ and X₁ to Xₙ may be perpendicular to the A electrodes A₁ to Aₘ. Here, a discharge space formed at an area where the A electrodes A₁ to Aₘ cross the X and Y electrodes X₁ to Xₙ and Y₁ to Yₙ may form a discharge cell 12. The configuration of the PDP 100 shown in FIG. 1 is an example, and other exemplary configurations may be applied in the present invention. Hereinafter, the X and Y electrodes extending by pairs in a row direction may be referred to as row electrodes, and the A electrodes extending in a column direction may be referred to as column electrodes.

The controller 200 may output X, Y, and A electrode driving control signals after receiving an external image signal. In addition, the controller 200 may drive the plasma display device by dividing a frame into a plurality of subfields, and may control the plasma display device by dividing the plurality of row electrodes into first and second row groups, and the first and second row groups into a plurality of respective subgroups.

The address electrode driver 300 may receive the address electrode driving control signal from the controller 200, and may apply a display data signal for selecting a discharge cell to be discharged to each respective address electrode A. The scan electrode driver 400 may receive a Y electrode driving control signal from the controller 200 and may apply a driving voltage to the Y electrode. The sustain electrode driver 500 may receive an X electrode driving control signal from the controller 200 and may apply a driving voltage to the X electrode. The temperature sensor 600 may detect the temperature of the PDP 100 and may transmit the temperature to the controller 200.

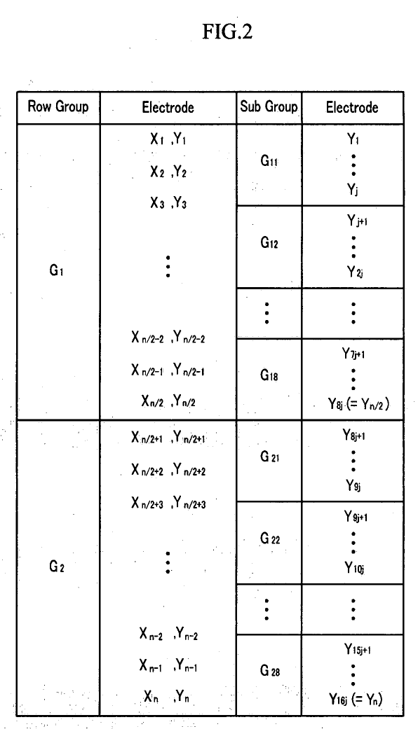

Referring to FIG. 2, a driving method of the plasma display device according to the exemplary embodiment of the present invention will now be described in more detail. FIG. 2 illustrates a method for grouping the respective electrodes used in a driving method of a plasma display device according to an exemplary embodiment of the present invention.

As shown in FIG. 2, one field may include two row groups, i.e., first and second row groups G₁ and G₂, into which the plurality of row electrodes X₁ to Xₙ and Y₁ to Yₙ may be divided. In the particular configuration illustrated in FIG. 2, the first row group G₁ may include a plurality of X electrodes X₁ to X_{n/2} and a plurality of Y electrodes Y₁ to Y_{n/2} in an upper portion of the PDP 100, and the second row group G₂ may include a plurality of X electrodes X_{(n/2)+1} to Xₙ and a plurality of Y electrodes Y_{(n/2)+1} to Yₙ in a lower portion of the PDP 100. Alternatively, the first row group G₁ may include even-numbered row electrodes and the second row group G₂ may include odd-numbered row electrodes.

In addition, the plurality of Y electrodes of the first and second row groups G₁ and G₂ respectively may again be divided into the plurality of subgroups G₁₁ to G₁₈ and G₂₁ to G₂₈. In the particular configuration illustrated in FIG. 2, the first and second row groups G₁ and G₂ are respectively divided into eight subgroups G₁₁ to G₁₈ and G₂₁ to G₂₈.

In particular, in the first row group G₁, first to j-th Y electrodes Y₁ to Yⱼ are grouped into a first subgroup G11, and (j+1)-th to 2j-th Y electrodes Yⱼ₊₁ to Y₂ⱼ are grouped into a second subgroup G12. In such a manner, (7j+1)-th to (n/2)-th Y electrodes Y₇ⱼ₊₁ to Y_{n/2} are grouped into an eighth subgroup G₈ (here, j is an integer between 1 and n/16). Likewise, in the second row group G₂, (8j+1)-th to 9j-th Y electrodes Y₈ⱼ₊₁ to Y₉ⱼ are grouped into a first subgroup G₂₁, and (9j+1)-th to 10j-th Y electrodes Y₉ⱼ₊₁ to Y₁₀ⱼ are grouped into a second subgroup G₂₂. In such a manner, (15j+1)-th to n-th Y electrodes Y₁₅ⱼ₊₁ to Yₙ are grouped into an eighth subgroup G₂₈. Alternatively, Y electrodes spaced at a predetermined interval or at irregular intervals in the first and second row groups G1 and G2 may be grouped into a respective subgroup.

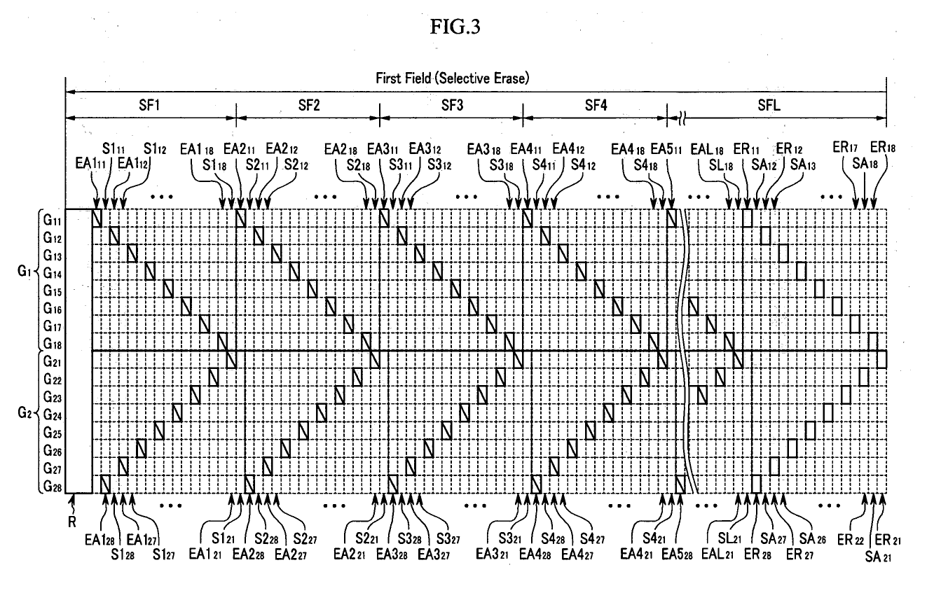

FIG. 3 illustrates a driving method of a plasma display device according to a first exemplary embodiment of the present invention. In FIG. 3, first to L-th subfields SF1 to SFL are illustrated with reference to the first row group G1.

Referring to FIG. 3, one field may include a plurality of subfields SF1 to SFL. In this particular example, the first to L-th subfields SF1 to SFL respectively include address periods EA1₁₁ to EAL₁₈ and EA1₂₁ to EAL₂₈, and sustain periods S1₁₁ to SL₁₈ and S1₂₁ to SL₂₈. As described with reference to FIG. 2, the plurality of row electrodes X₁ to Xₙ and Y₁ to Yₙ may be divided into the first and second row groups G₁ and G₂, and the first and second row groups G₁ and G₂ may be respectively divided into a plurality of subgroups G₁₁ to G₁₈ and G₂₁ to G₂₈.

A selective write method and a selective erase method may be respectively used to select discharge cells to emit light (hereinafter, called “light emitting cells”) and discharge cells to not emit light (hereinafter, called “non-light emitting cells”) among the plurality of discharge cells. The selective write method selects a light emitting cell and forms a constant wall voltage on the same. That is, the selective write method address-discharges cells in a non-light emitting state, forms a wall charge, and sets them to be light emitting cells. The selective erase method selects a non-light emitting cell and erases the formed wall voltage from the same. That is, the selective erase method address-discharges cells in a light emitting state, erases the formed wall charges, and sets them to be non-light emitting cells. Hereinafter, the address discharge for forming the wall charges in the selective write method will be referred to as a “write discharge,” and the address discharge for erasing the wall charges in the selective erase method will be referred to as an “erase discharge.”

Referring to FIG. 3, when the selective erase method is to be used to address the discharge cells, a reset period R may be provided immediately before the address period EA₁₁ of the first subfield SF1 provided foremost among the first to L-th subfields SF1 to SFL having the address periods EA1₁₁ to EAL₁₈ and EA1₂₁ to EAL₂₈, such that all the discharge cells are initialized and set in the light emitting cell state by the reset period R. That is, all the discharge cells may be initialized and set in the light emitting state during the reset period R, and may be set in a cell state that is capable of being erased during the address periods EA1₁₁ to EAL₁₈ and EA1₂₁ to EAL₂₈.

In the first subfield SF1, the address periods EA1₁₁ to EAL₁₈ and EA1₂₁ to EAL₂₈ and sustain periods S1₁₁ to SL₁₈ and S1₂₁ to SL₂₈ may be sequentially performed for the respective first to eighth subgroups G₁₁ to G₁₈ and G₂₁ to G₂₈ of the first and second row group G₁ and G₂. In the same manner as in the first subfield SF1, address periods EA2₁₁ to EAL₁₈ and EA2₂₁ to EAL₂₈ and sustain periods S2₁₁ to SL₁₈ and S2₂₁ to SL₂₈ of other subfields SF2 to SFL may be sequentially performed. Since operations of address periods EA1₁₁ to EAL₁₈ and EA1₂ to EAL₂₈ and sustain periods S1₁₁ to SL₁₈ and S1₂₁ to SL₂₈ of each subfield SF1 to SFL are substantially the same, operations of address periods EAk₁₁ to EAk₁₈ and EAk₂₁ to EAk₂₈ and sustain periods Sk₁₁ to Sk₁₈ and Sk₂₁ to Sk₂₈ of a k-th subfield SFk will be described (k is an integer between 1 and L).

At the k-th subfield SFk of the first row group G₁, an address period EAk₁ᵢ of an i-th subgroup G₁ᵢ may be performed and then a sustain period Sk₁ᵢ of the i-th subgroup G₁ᵢ may be performed (herein, i is an integer between 1 and 8). An address period EAk₁₍ᵢ₊₁₎ and a sustain period Sk₁₍ᵢ₊₁₎ of an (i+1)-th subgroup G₁₍ᵢ₊₁₎ may be consecutively performed. At the k-th subfield SFk of the second row group G₂, an address period EAk₂₍ᵢ₊₁₎ of an (i+1)-th subgroup G₂₍ᵢ₊₁₎ may be performed and then a sustain period Sk₁₍ᵢ₊₁₎ of an (i+1)-th subgroup G₂₍ᵢ₊₁₎ may be performed. Next, an address period EAk₂ᵢ and a sustain period Sk₂ᵢ of an i-th group G₂ᵢ may be performed. When the sustain period Sk₁ᵢ of the i-th subgroup G₁ᵢ of the first row group G₁ is performed at the k-th subfield SFk, an address period EAk₂₍₈₋₍ᵢ₋₁₎₎ of an (8−(i−1))-th subgroup G₂₍₈₋₍ᵢ₋₁₎₎ of the second row group G₂ may be performed. When the sustain period Sk₂₍₈₋₍ᵢ₋₁₎₎ of the (8−(i−1))-th subgroup G₂₍₈₋₍ᵢ₋₁₎₎ of the second row group G₂ is performed at the k subfield SFk, the address period EAk₁₍ᵢ₊₁₎ of the (i+1)-th subgroup G₁₍ᵢ₊₁₎ of the first row group G₁ may be performed.

In FIG. 3, at the second row group G₂, the address periods EAk₂₈ to EAk₂₁ and sustain periods Sk₂₈ to Sk₂₁ may be sequentially performed from the eighth subgroup G₂₈ to the first subgroup G₂₁ in the second row group G₂. Alternatively, in the second row group G₂, the address periods EAk₂₁ to EAk₂₈ and sustain periods Sk₂₁ to Sk₂₈ may be subsequently performed from the first subgroup G₂₁ to the eighth subgroup G₂₈ in the same manner as in the first row group G₁. In addition, in the first and the second row groups G₁ and G₂, the address and sustain periods may be performed in a different sequence from that shown in FIG. 3.

In further detail regarding the respective subfields SF1 to SFL of the first row group G₁, cells to be set as non-light emitting cells from among the light emitting cells of the first subgroup G₁₁ may be erase discharged to erase the wall charge in the address period EAk₁₁ of the first subgroup G₁₁ in the k-th subfield (SFk) of the first row group G₁, and other light emitting cells of the first subgroup G₁₁ may be sustain discharged in the sustain period Sk₁₁. Discharge cells to be selected as a non-light emitting cells from among the light emitting cells of the second subgroup G₁₂ may be erase discharged to erase the wall charge in the address period EAk₁₂ of the second subgroup G₁₂, and other light emitting cells of the second subgroup G₁₂ may be sustain discharged in the sustain period Sk₁₂. In this instance, light emitting cells of the first subgroup G₁₁ may be sustain discharged. In a like manner, the address periods EAk₁₃ to EAk₁₈ and the sustain periods Sk₁₃ to Sk₁₈ may be performed for the other subgroups G₁₃ to G₁₈.

Thus, during the sustain period Sk₁ᵢ of the i-th subgroup G₁ᵢ, the light emitting cells of the i-th subgroup G₁ᵢ and the light emitting cells of the first to (i−1)-th subgroups G₁₁ to G₁₍ᵢ₋₁₎ and the (i+1) to eighth subgroups G₁₍ᵢ₊₁₎ to G₁₈ may be sustain discharged. The light emitting cells of the first to (i−1)-th subgroups G₁₁ to G₁₍ᵢ₋₁₎ are light emitting cells at which no erase discharge is generated in the respective address periods EAk₁₁ to EAk₁₍ᵢ₋₁₎ of the k-th subfield SFk, and the light emitting cells of the (i+1)-th to eighth subgroups G₁₍ᵢ₊₁₎ to G₁₈ are light emitting cells at which no erase discharge is generated in the address periods EA₍ₖ₋₁₎₁₍ᵢ₊₁₎ to EA₍ₖ₋₁₎₁₈ of the (k−1)-th subfield SF(k−1). The light emitting cell of the i-th subgroup G₁ᵢ may be sustain discharged up to the sustain period SK1(i−1) before the address period EA₍ₖ₊₁₎₁ᵢ of the i-th subgroup G₁ᵢ of the (k+1)-th subfield SF(k+1). That is, the light emitting cells of the i-th subgroup G₁ᵢ may be sustain discharged during the eight sustain periods.

Accordingly, the address periods EA2₁₁ to EA2₁₈, . . . , and EAL₁₁ to EAL₁₈ and sustain periods S2₁₁ to S2₈, . . . , SL₁₁ to SL₁₈ may be performed for the respective subgroups G₁₁ to G₁₈ of all the subfields SF1 to SFL. Therefore, the discharge cells that are set as light emitting cells during the reset period R may consecutively perform a sustain discharge until the discharge cells are set to be non-light emitting cells by the erase discharges at the respective subfields SF1 to SFL. When the discharge cells are switched to non-light emitting cells by the erase discharges, these discharge cells may not be sustain-discharged after the corresponding subfields. At this time, the respective subfields SF2 to SFL have weight values corresponding to a sum of the lengths of the eight sustain periods of the respective subfields SF2 to SFL.

After the sustain period SL₁₈ has been performed the last subfield SFL, the first subgroup G₁₁ has been sustain discharged a total of eight times, the second subgroup G₁₂ has been sustain discharged a total of seven times, and the third subgroup G₁₃ has been sustain discharged a total of six times. The fourth subgroup G₁₄ has been sustain discharged a total of five times, the fifth subgroup G₁₅ has been sustain discharged a total of four times, and the sixth subgroup G₁₆ has been sustain discharged a total of three times. In addition, the seventh subgroup G₁₇ has been sustain discharged twice, and the eighth subgroup G₁₈ has been sustain discharged once. Accordingly, the last subfield SFL of the first row group G₁ may have erase periods ER₁₁ to ER₁₇ and additional sustain periods SA₁₂ to SA₁₈ such that the number of sustain discharges of the first to eighth subgroups G₁₁ to G₁₈ are the same.

In detail, the first subgroup G₁₁ having undergone a total of eight sustain discharges just before the erase period ER₁₁ may not need an additional sustain discharge. Accordingly, the wall charges formed in all the discharge cells of the first subgroup G₁₁ may be erased during the erase period ER₁₁. Then, during the additional sustain period SA₁₂, the light emitting cells of the first to eighth subgroups G₁₁ to G₁₈ are sustain-discharged. At this time, since the wall charges formed in all the discharge cells of the first subgroup G₁₁ were erased during the erase period ER₁₁, during the additional sustain period SA₁₂ an additional sustain discharge may be generated once in the light emitting cells second to eighth subgroups G₁₂ to G₁₈.

Since all the discharge cells of the second subgroup G₁₂ have undergone a total of eight sustain discharges due to the additional sustain period SA₁₂, the wall charges formed in all the discharge cells of the second subgroup G₁₂ may be erased during the erase period ER₁₂. During the additional sustain period SA₁₃, the light emitting cells of the first to eighth subgroups G₁₁ to G₁₈ are sustain-discharged. Since the wall charges formed in all the discharge cells of the first and second subgroups G₁₁ and G₁₂ were erased during the each erase period ER₁₁ and ER₁₂, during the additional sustain period SA₁₃, an additional sustain discharge may be generated once in the light emitting cells of the third to eighth subgroups G₁₃ to G₁₈.

Since all the discharge cells of the third subgroup G₁₃ have undergone a total of eight sustain discharges due to the additional sustain period SA₁₃, the wall charges formed in all the discharge cells of the third subgroup G₁₃ may be erased during the erase period ER₁₃. During the additional sustain period SA₁₄, the light emitting cells of the first to eighth subgroups G₁₁ to G₁₈ are sustain-discharged. Since the wall charges formed in all the discharge cells of the first to third subgroups G₁₁ to G₁₃ were erased during the respective erase periods ER₁₁ to ER₁₃, during the additional sustain period SA₁₃, an additional sustain discharge may be generated once in the light emitting cells of the fourth to eighth subgroups G₁₄ to G₁₈.

In a like manner, the number of sustain discharges of the first to eighth subgroups G₁₁ to G₁₈ may be the same when the erase periods ER₁₄ to ER₁₇ and the additional sustain periods SA₁₅ to SA₁₈ are performed.

An erase period ER₁₈ for erasing the wall charges of the eighth subgroup G₁₈ may be formed after the additional sustain period SA₁₈ of the eighth subgroup G₁₈. When the reset period R is to be performed at the first subfield SF1 of the next field, the erase period ER₁₈ of the eighth subgroup G₁₈ may be omitted. The erase operation of such erase periods ER₁₁ to ER₁₈ may be sequentially performed for the respective row electrodes of the respective subgroups as in the address period, and may be simultaneously performed for all the row electrodes of the respective row groups.

Regarding the respective subfields SF1 to SFL of the second row group G₂, the respective subfields SF1 to SFL of the second row group G₂ may have substantially the same structure as the respective subfields SF1 to SFL of the first row group G₁. As described above, at the respective subfields SF1 to SFL of the second row group G₂, the address periods EA1₂₈ to EA1₂₁, . . . , EAL₂₈ to EAL₂₁ may be subsequently performed in the order of from the eighth subgroup G₂₈ to the first subgroup G₂₁, and also, the erase period ER₂₁ to ER₂₈ of the last subfields SFL of the second row group G₂ may be subsequently performed in the order of from the eighth subgroup G₂₈ to the first subgroup G₂₁.

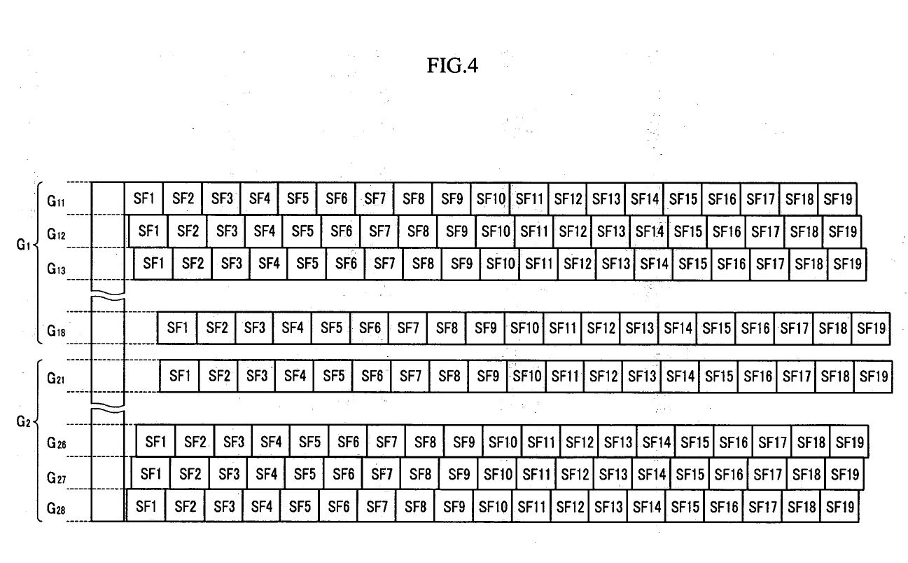

FIG. 4 illustrates the plasma display device driving method using the subfields. In FIG. 4, one field may include nineteen subfields SF1 to SF19. When the selective erase method is to be used for addressing the discharge cells, the subfields SF1 to SF19 may be shifted by a predetermined interval in the respective subgroups G₁₁ to G₁₈ and G₂₈ to G₂₁ of the first and second row groups G₁ to G₂. The predetermined interval may correspond to the length of the address period (EAk₁ᵢ or EAk₂ᵢ) of one subgroup (G₁ᵢ or G₂ᵢ) and the sustain period (Sk₁ᵢ or Sk₂ᵢ) of one subgroup (G₁ᵢ or G₂ᵢ). When it is assumed that the length of the address period (EAk₁ᵢ or EAk₂ᵢ) of one subgroup (G₁ᵢ or G₂ᵢ) corresponds to that of the sustain period (Sk₁ᵢ or Sk₂ᵢ) of one subgroup (G₁ᵢ or G₂ᵢ), starting points of the respective subfields SF1 to SF19 of the second row group G₂ may be shifted from the starting point of the respective subfields SF1 to SF19 of the first row group G₁ by the length of the address period (EAk₁ᵢ or EAk₂ᵢ).

Accordingly, the sustain period may be performed for the row electrodes of the second row group G₂ during the address period of the row electrodes of the first row group G₁, and the sustain period may be performed for the row electrodes of the second row group G₂ during the address period of the row electrodes of the first row group G₁. That is, the length of the one subfield may be reduced because the address and sustain periods are not separated, and the sustain period may be performed during the address period. In addition, since priming particles formed during the sustain period may be sufficiently used during the address period, in that the address periods are disposed between the sustain periods of the respective subgroups, the width of the scan pulse may become shorter, thereby increasing the speed of the scan. Further, the contrast ratio may be increased since no strong discharge is generated in the reset period.

No false contour may occur, since the grayscale is expressed by consecutive subfields before an erase discharge is generated in the corresponding subfield from among a plurality of subfields SF1 to SF19, and discharge cells in a light emitting cell state are switched to a non-light emitting cell. The grayscales that are not expressed by the combination of weights of the respective subfield SF1 to SF19 may be expressed by dithering.

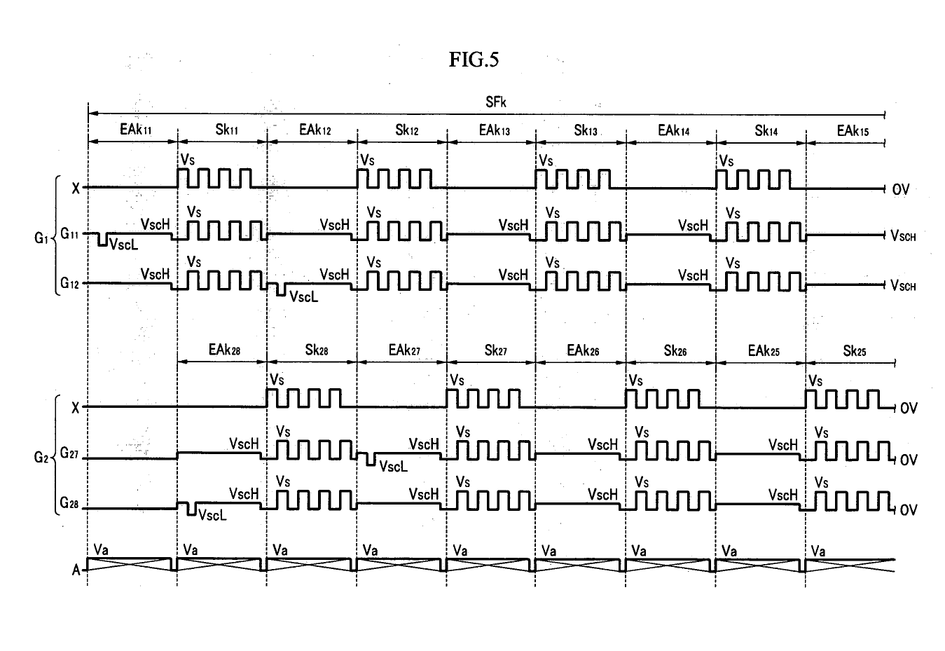

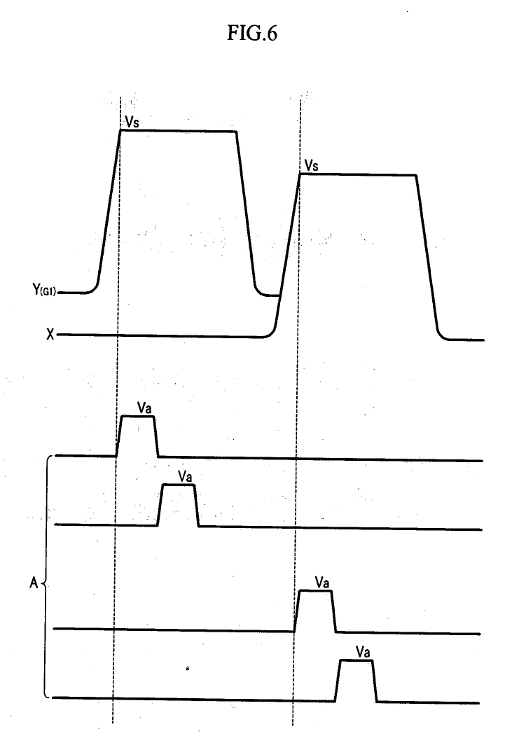

A driving waveform used for the plasma display device driving method shown in FIG. 3 will now be described with reference to FIG. 5 and FIG. 6.

FIG. 5 and FIG. 6 respectively show a detailed plasma display device driving waveform for the driving method shown in FIG. 3. For better understanding and ease of description, in FIG. 5, the first and second subgroups G₁₁ and G₁₂ of the first row group G₁, and the seventh and eighth subgroups G₂₇ and G₂₈ of the second row group G₂ are illustrated for the one subfield SFk, and FIG. 6 illustrates a sustain period from among the sustain periods S1₁₁ to S1₁₈ of the first row group shown in FIG. 5.

As shown in FIG. 5 and FIG. 6, during the address period EAk₁₁ of the first subgroup G₁₁ of the k-th subfield SFk of the first row group G₁, a scan pulse having a voltage of V_{SCL} may be applied to a plurality of Y electrodes of the first subgroup G₁₁ while a reference voltage (0V voltage in FIG. 5) may be applied to the X electrodes of the first row group G₁. At this time, the address pulse having a voltage Va may be applied to the A electrodes of the cells to be selected as the non-light emitting cells from among the light emitting cells formed by the Y electrodes applied with the scan pulse. In addition, a voltage V_{SCH} that is greater than the voltage V_{SCL} may be applied to the Y electrodes in the first row group G₁ to which no scan pulse is applied, and the reference voltage may be applied to the A electrodes to which no address pulse is applied. An erase discharge may be generated in the light emitting cell to which the scan pulse having the voltage V_{SCL} and the address pulse having the voltage the voltage Va are applied, thereby erasing wall charges formed at the X electrodes and the Y electrodes and setting the discharge cell to be a non-light emitting cell.

As shown in FIG. 5, and referring again to FIG. 1, the scan pulse having the voltage V_{SCL} may be applied to one Y electrode in the address period EAk₁₁, and the scan electrode driver 400 sequentially may select the Y electrode to which the scan pulse will be applied from among a plurality of Y electrodes in to the first subgroup G₁₁ in the address period EAk₁₁. For example, when driven individually, the Y electrodes may be selected in the order of their arrangement in the vertical direction. When a Y electrode is selected, the address electrode driver 300 selects a light emitting cell from among the discharge cells formed by the corresponding Y electrode. That is, the address electrode driver 300 may select a cell to which an address pulse with the voltage of Va will be applied from among the A electrodes A1 to Am.

During the sustain period Sk₁₁ of the first subgroup G₁₁, the sustain pulse having a high-level voltage, e.g., a voltage Vs in FIG. 5, and a low-level voltage, e.g., 0V in FIG. 5, may be applied in inverse phases to the plurality of X electrodes of the first row group G₁ and the Y electrodes of the first to eighth subgroups G₁₁ to G₁₈. Accordingly, the light emitting cells of the first subgroup G₁₁ are sustain-discharged. That is, the voltage 0V may be applied to the Y electrode when the voltage Vs is applied to the X electrode, and the voltage 0V may be applied to the X electrode when the voltage of Vs is applied to the Y electrode. At this time, the cells having undergone no erase discharge during the address period EAk₁₁ among the cells of the light emitting cell state of just before the subfield SF(k−1) may be in the light emitting cell state, and accordingly, such a light emitting cell may be sustain-discharged.

Then, during the address period EAk₁₂ of the second subgroup G₁₂, the scan pulse of the voltage V_{SCL} may be sequentially applied to the plurality of Y electrodes of the second subgroup G₁₂ while the reference voltage is applied to the X electrodes of the first row group G₁, and the address pulse having the voltage Va may be applied to the A electrodes of the cells to be selected as the non-light emitting cells among the light emitting cells formed by the Y electrodes applied with the scan pulse.

In addition, the sustain pulse is applied in inverse phases to the plurality of X electrodes of the first row group G₁ and the Y electrodes of the first to eighth subgroups G₁₁ to G₁₈ during the sustain period Sk₁₂, and accordingly, the light emitting cells are sustain-discharged. In such a manner, the address periods EAk₁₃ to EAk₁₈ and the sustain periods Sk₁₃ to Sk₁₈ may be performed for the other subgroups G₁₃ to G₁₈.

The address period EAk₂₈ of the eighth subgroup G₂₈ may be performed in the second row group G₂, while the sustain period Sk₁₁ of the first subgroup G₁₁ is performed in the k-th subfield SFk of the first row group G₁.

At the k-th subfield SFk of the second row group G₂, during the address period EAk₂₈ of the eighth subgroup G₂₈, the scan pulse of the voltage V_{SCL} may be sequentially applied to the plurality of Y electrodes of the eighth subgroup G₂₈, while the reference voltage is applied to the X electrodes of the second row group G₂, and the address pulse having the voltage Va is applied to the A electrodes of the cells to be selected as the non-light emitting cells from among the light emitting cells formed by the Y electrodes applied with the scan pulse. During the sustain period Sk₂₈, the sustain pulse may be applied in inverse phases to the plurality of X electrodes of the second row group G₂ and the Y electrodes of the first to eighth subgroups G₂₁ to G₂₈ of the second row group G₂, and accordingly, the light emitting cells may be sustain-discharged.

At this time, the address period EAk₁₂ of the second subgroup G₁₂ may be performed at the first row group G₁ while the sustain period Sk₂₈ is performed at the k-th subfield SFk of the second row group G₂. In such a manner, the address periods EAk₂₇ to EAk₂₁ and the sustain periods Sk₂₇ to Sk₂₁ may be performed for other subgroups G₂₇ to G₂₁.

As such, according to a first exemplary embodiment of the present invention, the address period for one row group G₂ or G₁ may be performed concurrently with the sustain period for the other row group G₁ or G₂. That is, while the sustain discharge is generated between the plurality of X and Y electrodes of the first row group G₁ when the voltage Vs is applied to the plurality of Y and the voltage 0V is applied to the plurality of X electrodes, or the voltage Vs is applied to the plurality of X electrodes and the voltage 0V is applied to the plurality of Y electrodes, the address pulse may be applied to the A electrodes of the cells to be selected as the non-light emitting cells in any one subgroup EAk₂ᵢ of the second row group G₂.

Likewise, while the sustain discharge is generated between the plurality of X and Y electrodes of the second row group G₂ when the voltage Vs is applied to the plurality of Y electrodes and the voltage 0V is applied to the plurality of X electrodes, or the voltage Vs is applied to the plurality of X electrodes and the voltage 0V is applied to the plurality of Y electrodes, the address pulse may be applied to the A electrodes of the cells to be selected as the non-light emitting cells in any one subgroup EAk₁ᵢ of the first row group G₁. As such, if the sustain discharge is generated between the plurality of X and Y electrodes of the first row group G₁ or between the plurality of X and Y electrodes of the second row group G₂, the address pulse may be applied to the A electrodes while the wall charges are re-positioned on the electrodes, and accordingly, few ions may be accumulated on the A electrodes due to the address pulse. Accordingly, the weak erase discharge may occur or the erase discharge may not occur.

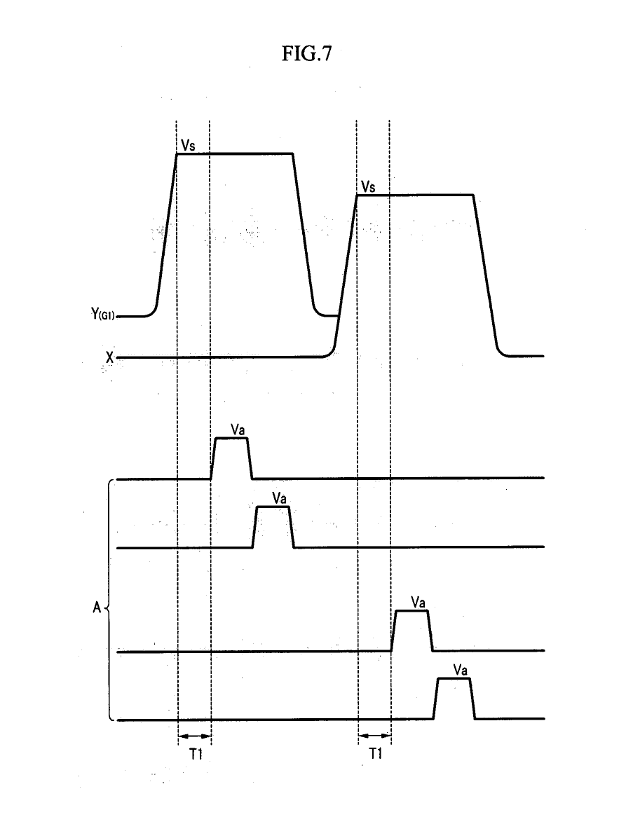

A stable generation of erase discharge will now be described with reference to FIG. 7. FIG. 7 illustrates a driving waveform according to an exemplary embodiment of the present invention.

As shown in FIG. 7, when the voltage 0V is applied to a plurality of X electrodes of the first row group G₁ and the voltage Vs is applied to a plurality of Y electrodes of the first row group G₁, the non-light emitting cell may not be selected during a period in which the voltage at a plurality of Y electrodes is changed from the voltage 0V to the voltage Vs, a period in which the voltage of Vs is changed to 0V, and a predetermined period T1 after a period in which the voltage of Vs is applied to a plurality of Y electrodes. That is, after the voltage at the Y electrodes has been maintained at Vs for the predetermined period T1, the scan pulse may be sequentially applied to the Y electrodes and the address pulse may be applied to the A electrode of the non-light emitting cell from among the light emitting cells formed by the Y electrode to which the scan pulse is applied, to thus select the non-light emitting cell. Also, when the voltage Vs is applied to a plurality of X electrodes of the first row group G₁ and the voltage 0V is applied to a plurality of Y electrodes of the first row group G₁, the non-light emitting cell may not be selected during a period in which the voltage at a plurality of X electrodes is changed from the voltage 0V to the voltage Vs, a period in which the voltage Vs is changed to the voltage 0V, and a predetermined period T1 after the voltage of Vs is applied to the X electrodes, which may be applied to the second row group G₂ in a like manner. Therefore, fewer positive ions may be accumulated at the A electrode, since the non-light emitting cell may be selected when the rearrangement of wall charges at the respective electrodes is almost finished. Therefore, the following erase discharge may be stably performed.

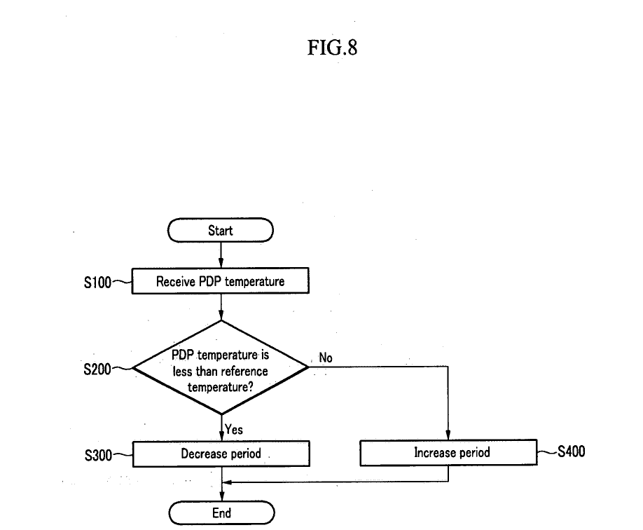

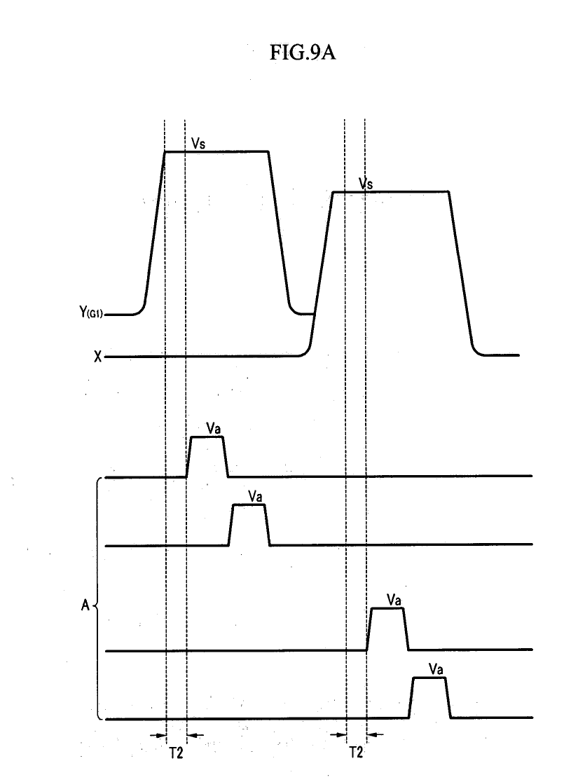

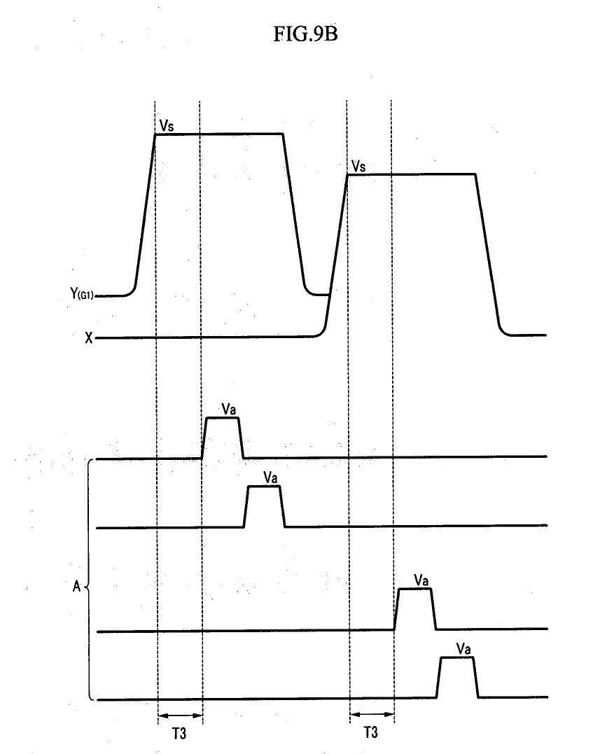

The PDP 100 may have different discharge characteristics depending on the temperature. In detail, a discharge firing voltage and a discharge delay may decrease when the temperature of the PDP 100 increases, and the discharge firing voltage and the discharge delay may increase when the temperature of the PDP 100 decreases. Particularly, the discharge delay may be increased to generate a sustain discharge after the predetermined period T1 when the PDP 100 is at a low temperature, and positive ions may be formed at the A electrode by the address pulse when the wall charges caused by the sustain discharge are formed at the X, Y, and A electrodes. Then, the erase discharge may not be easily generated. A method for generating a stable erase discharge of the PDP 100 according to the temperature of the PDP in accordance with an embodiment of the present invention will now be described with reference to FIG. 8, FIG. 9A, and FIG. 9B.

FIG. 8 illustrates a method of operating the controller 200 shown in FIG. 1, and FIG. 9A and FIG. 9B respectively illustrate driving waveforms of a sustain period according to an exemplary embodiment of the present invention.

As shown in FIG. 8, on receiving the sensed temperature of the PDP 100 from the temperature sensor 600 (S100), the controller 200 may compare the temperature of the PDP 100 to a reference temperature (S200) or reference temperature range. In this instance, when the temperature of the PDP 100 is equal to the reference temperature or within the reference temperature range, a control signal may be output to the Y electrode and the A electrode so as to select the non-light emitting cell after the predetermined period T1, as illustrated in FIG. 7. When the temperature of the PDP 100 exceeds the reference temperature or reference temperature range, the controller 200 may decrease the period (S300). When the temperature of the PDP 100 is lower than the reference temperature or reference temperature range, the controller 200 may increase this period (S400).

That is, as shown in FIG. 9A, when the temperature PDP 100 is exceeds the reference temperature or reference temperature range, the controller 200 may output a control signal for selecting the non-light emitting cell after a period T2 that is shorter than the predetermined period T1 to the Y electrode and the A electrode. Accordingly, when the temperature of the PDP 100 is greater than the reference temperature, a sustain discharge may be generated after the period T2 when the period T2 is short, thus reducing the discharge delay, and the sustain period of the respective subgroups may be reduced since the width of the sustain pulse may be reduced.

As shown in FIG. 9B, when the temperature of the PDP 100 is less than the reference temperature or reference temperature range, the controller 200 may output a control signal for selecting a non-light emitting cell after a period T3 that is longer than the period T1 to the Y electrode and the A electrode. Therefore, the sustain discharge may be generated after the period T3 by setting the period T3 to be long when the temperature of the PDP 100 is less than the reference temperature, thus the discharge delay may be increased, and the sustain discharge may not substantially influence the amount of positive ions accumulated at the A electrode since the address pulse is applied to the A electrode after the period T3.

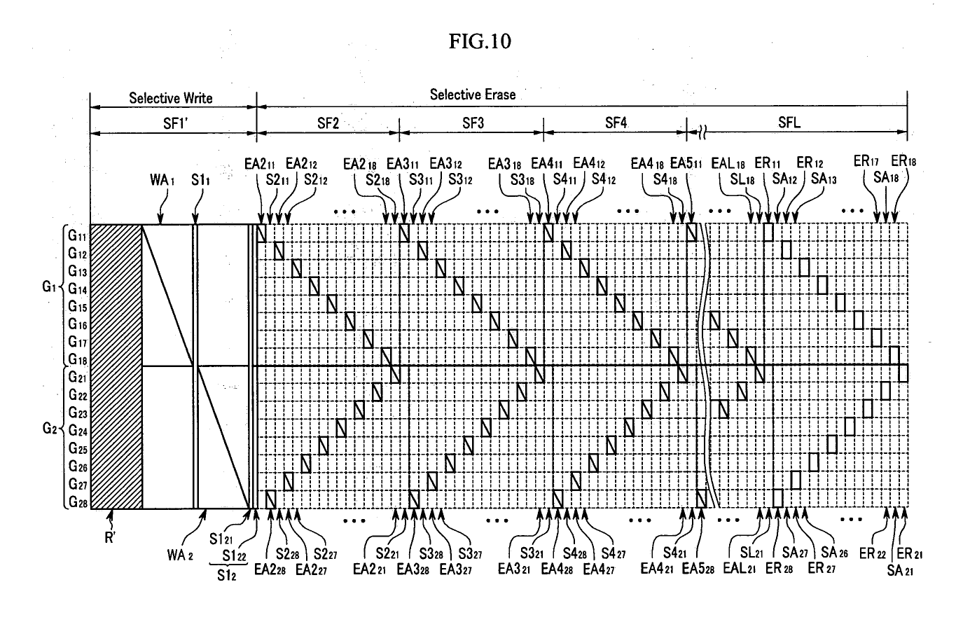

According to the first exemplary embodiment of the present invention, discussed above referring to FIG. 3, a strong reset discharge may be performed to initialize all the discharge cells during the reset period R and set a light emitting cell state. In this case, the contrast ratio may be deteriorated, since a black screen may appear bright. In addition, it may be difficult to form enough wall charges to set all the discharge cells as light emitting cells with only the reset period R. A method for improving the contrast ratio and stably generating an erase discharge will now be described with reference to FIG. 10.

FIG. 10 illustrates a method for driving a plasma display device according to a second exemplary embodiment of the present invention.

As shown in FIG. 10, the driving method according to the second exemplary embodiment of the present invention is similar to the driving method according to the first exemplary embodiment. However, unlike in the first exemplary embodiment, the selective write method may be used during address periods WA₁ and WA₂ of a first subfield SF1′. Since the address period WA₁ or WA₂ of the subfield SF1′ use the selective write method, a reset period R′ may be provided in which the light emitting cells are initialized into the non-light emitting cells during the reset period R′ immediately before the address period WA₁ or WA₂. That is, discharge cells may be initialized to be in the non-light emitting cell state during the reset period R′ immediately before the address period WA₁ or WA₂, in contrast to the first exemplary embodiment of the present invention, in which discharge cells are initialized to be in the light emitting cell state in the reset period R immediately before the address periods EA1₁₁ to EAL₁₈ and EA1₂₁ to EAL₂₈.

In order to initialize a discharge cell as a non-light emitting cell during the reset period R′ of the first subfield SF′, the reset period R′ may be realized by gradually increasing and then gradually decreasing a voltage. For example, the voltage of the plurality of Y electrodes may be gradually increased and then gradually decreased during the reset period R′. While the voltage at the Y electrode is increased, a weak reset discharge may be generated between the Y electrode and the X electrode to form wall charges in the discharge cell. While the voltage at the Y electrode is decreased, a weak reset discharge may be generated between the Y electrode and the X electrode to erase the wall charges formed in the discharge cell. Hence, the discharge cell may be reset to be a non-light emitting cell. As a result, no strong discharge may be generated in the reset period R′, thereby enhancing the contrast ratio.

During the address period WA₂ of the first subfield SF1′, the write discharge may be generated in the discharge cells to be set as the non-light emitting cells among the discharge cells of the second row group G₂, and accordingly the wall charges may be generated. Then, during a partial period S1₂₁ of the sustain period S1₂, the light emitting cells of the first and second row groups G₁ and G₂ may be sustain-discharged. In addition, during another partial period S1₂₂ of the sustain period S1₂, the sustain discharge may not be generated in the light emitting cells of the first row group G₁ but rather in the second row group G₂. In this instance, the number of sustain discharges to be generated in the light emitting cells of the second row group G₂ during the partial period S1₂₂ of the sustain period S1₂ may equal the number of sustain discharges in the light emitting cells of the first row group G₁ during the sustain period S1₂.

When the weight value of the first subfield SF′ may not be expressed by the two sustain periods S1₁ and S1₂, the light emitting cells of the first and second row groups G₁ and G₂ may be the additionally sustain discharged during the partial period S1₂₂ of the sustain period S1₂.

In such a manner, the wall charges may be sufficiently formed on the respective electrodes of the light emitting cells before the subfields SF2 to SFL are addressed using the selective erase method.

In FIG. 3 and FIG. 10, at the last subfield SFL of one field, the erase periods ER1₁₂ to ER1₁₈ and ER1₂₂ to ER1₂₈ and the additional sustain periods SA₁₂ to SA₁₈ and SA₂₂ to SA₂₈ of the first and second row groups G₁ and G₂ may be present or may be omitted. When the erase periods ER1₁₂ to ER1₁₈ and ER1₂₂ to ER1₂₈ and the additional sustain periods SA₁₂ to SA₁₈ and SA₂₂ to SA₂₈ are omitted, the addressing order of the respective subgroups G₁₁ to G₁₈ and G₂, to G₂₈ among the respective groups G₁ and G₂ over the plurality of fields may be changed. Hence, the number of sustain discharges of the respective row groups may be the same.

While this invention has been described in connection with exemplary embodiments, it is to be understood that the invention is not limited to the disclosed exemplary embodiments, but, on the contrary, is intended to cover various modifications and equivalent arrangements included within the spirit and scope of the appended claims.

As described above, according to the present invention, a plurality of row electrodes may be divided into the first and second row groups, and the row electrodes of the respective groups may be divided into a plurality of subgroups. The address period for the respective subgroups of the first and second row groups may be performed in the respective subfields of a field, and the sustain period may be performed between the address periods of the respective subgroups. Also, the address period for the respective subgroups of the second row group may be performed while the sustain period for the respective subgroups of the first row group is performed, and the sustain period for the respective subgroups of the first row group may be performed during the address period for the respective subgroups of the second row group. In this instance, a non-light emitting cell may be selected from a row group after a sustain discharge is generated in another row group, and the erase discharge may be stably generated by controlling a predetermined period depending on the temperature.

Since the address period may be formed between sustain periods of the respective subgroups to sufficiently use the priming particles generated in the sustain period in the address period, high-speed scanning may be possible by shortening the scan pulse width, the widths of the scan pulse and address pulse may be further shortened in the subfield having many sustain pulses, and the length of a subfield can be reduced since the sustain period may be performed during the address period.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving a plasma display device having a plurality of row electrodes, a plurality of column electrodes, and a plurality of discharge cells defined by the plurality of row and column electrodes, wherein one field is divided into a plurality of subfields, the driving method comprising, at each of a plurality of consecutive first subfields:
dividing the row electrodes into a first row group and a second row group, dividing the first row group into a plurality of first subgroups, and dividing the second row group into a plurality of second subgroups;
alternately applying a low voltage and a high voltage to row electrodes of at least one second subgroup; and
selecting a non-light emitting cell from among light emitting cells of at least one first subgroup after a predetermined period among a period for applying the high voltage to the row electrodes of the at least one second subgroup.

2. The method as claimed in claim 1, wherein the predetermined period is inversely proportional to a temperature of the plasma display device.

3. The method as claimed in claim 1, wherein the non-light emitting cell is not selected while the voltage at the row electrodes of the at least one second subgroup changes from the high voltage to the low voltage, changes from the low voltage to the high voltage, and during the predetermined period.

4. The method as claimed in claim 1, wherein:
the row electrodes include a plurality of first electrodes and a plurality of second electrodes, and
alternately applying the low voltage and the high voltage includes applying the low voltage and the high voltage in opposite phases to the first electrodes and the second electrodes in the at least one second row subgroup.

5. The method as claimed in claim 4, wherein the selecting of the non-light emitting cell from among the light emitting cells of the first subgroup comprises:
sequentially applying a scan pulse to the first electrode belonging to the at least one first subgroup; and
applying an address pulse to the column electrode of the non-light emitting cell from among the light emitting cells formed by the first electrode to which the scan pulse is applied.

6. The method as claimed in claim 1, wherein the period for applying the high voltage to the row electrode is directly proportional to a temperature of the plasma display device.

7. The method as claimed in claim 1, further comprising:
alternately applying the low voltage and the high voltage to the row electrode of at least one first subgroup; and
selecting a non-light emitting cell from among light emitting cells of at least one second subgroup after the high voltage is applied to the row electrodes of the at least one second subgroup for the predetermined period.

8. The method as claimed in claim 1, further comprising, during second subfields prior to the plurality of first subfields:
selecting light emitting cells from discharge cells of the first row group and sustain-discharging light emitting cells of the first row group of light emitting cells; and
selecting light emitting cells from discharge cells of the second row group and sustain-discharging light emitting cells of the second row group.

9. The method as claimed in claim 8, further comprising, during the second subfields, setting the plurality of discharge cells as non-light emitting cells before selecting the light emitting cells from among the first row group of discharge cells.

10. A plasma display device, comprising:
a plasma display panel (PDP) including a plurality of row electrodes, a plurality of column electrodes, and a plurality of discharge cells defined by the row electrodes and the column electrodes;
a controller configured to divide a field into a plurality of subfields, the row electrodes into a first row group and a second row group, and the row electrodes of the first and second row groups into a plurality of first subgroups and a plurality of second subgroups, respectively; and
a driver configured to apply a sustain pulse to the row electrodes belonging to the second subgroups while selecting a non-light emitting cell from among light emitting cells of the first subgroups during a first period, and to apply the sustain pulse to the row electrodes belonging to the first subgroups while selecting a non-light emitting cell from among the light emitting cells of the respective second subgroups during a second period,
wherein the sustain pulse alternately has a low level voltage and a high level voltage, and
the driver selects the non-light emitting cell after a predetermined period among a period for applying the high voltage to the row electrodes.

11. The plasma display device as claimed in claim 10, wherein the driver does not select the non-light emitting cell while the sustain pulse has the low level voltage and during the predetermined period.

12. The plasma display device as claimed in claim 10, further comprising a temperature sensor for sensing a temperature of the PDP, wherein the controller sets the predetermined period in accordance with the temperature of the PDP.

13. The plasma display device as claimed in claim 10, wherein the driver applies a first voltage to the column electrode of the selected non-light emitting cell, and applies a second voltage that is lower than the first voltage to the column electrode of a non-light emitting cell that is not selected.

14. A method of driving a plasma display device having a plurality of row electrodes, a plurality of column electrodes, and a plurality of discharge cells defined by the plurality of row and column electrodes, each of the row electrodes including a first electrode and a second electrode, wherein one field is divided into a plurality of subfields, the method comprising:
dividing the first electrodes into a first row group and a second row group, dividing the first electrodes of the first row group into a plurality of first subgroups, and dividing the first electrodes of the second row group into a plurality of second subgroups;
in at least one subfield from among the subfields, applying a first sustain pulse and a second sustain pulse in opposite phases to the first electrode and the second electrode of light emitting cells of at least one second subgroup, and selecting a non-light emitting cell from among light emitting cells of at least one first subgroup; and
in the at least one subfield, applying the first sustain pulse and the second sustain pulse in opposite phases to the first electrode and the second electrode of the light emitting cells of at least one first subgroup, and applying an address pulse to a column electrode of a non-light emitting cell from among light emitting cells of the at least one second subgroup,
wherein the first and second sustain pulses alternately have a high level voltage and a low level voltage, and
the address pulse is applied to the column electrode of the non-light emitting cell after a predetermined period among a period of the high level voltage of the sustain pulse.

15. The method as claimed in claim 14, wherein the predetermined period is determined based on a temperature of the plasma display device.

16. The method as claimed in claim 15, wherein the predetermined period is inversely proportional to the temperature of the plasma display device.

17. The method as claimed in claim 14, further comprising, during a second subfield prior to a first subfield:
selecting light emitting cells from discharge cells of the first row group and sustain-discharging light emitting cells of the first row group; and
selecting light emitting cells from discharge cells of the second row group and sustain-discharging light emitting cells of the second row group.

18. The method as claimed in claim 17, wherein in the second subfield, the discharge cells are set to be non-light emitting cells before selecting the light emitting cells from among the discharge cells of the first row group.

19. The method as claimed in claim 14, wherein the predetermined period is increased when a temperature of the plasma display device is lower than a reference temperature and decreased when the temperature of the plasma display device is higher than the reference temperature.

20. The method as claimed in claim 14, wherein the period of the high level voltage of the sustain pulse is directly proportional to a temperature of the plasma display device.
